(19) United States
(12) Patent Application Publication
(10) Pub. No.: US 2010/0255300 A1
(43) Pub. Date: Oct. 7, 2010

(54) PRESSURE-SENSITIVE ADHESIVE TAPE AND METHOD FOR PRODUCTION THEREOF

(75) Inventors: Catherine Coutey, Houppeville (FR); Claire Leddet, Rouen (FR); Jean-Loup Masson, Bois-Guillaume (FR)

Correspondence Address: LUCAS & MERCANTI, LLP, 475 PARK AVENUE SOUTH, 15TH FLOOR, NEW YORK, NY, 10016, US

(73) Assignee: NOVACEL, Deville-Les-Rouen (FR)

(21) Appl. No.: 12/819,855

(22) Filed: Jun. 21, 2010

Related U.S. Application Data
(62) Division of application No. 10/599,883, filed on Nov. 29, 2006.

(30) Foreign Application Priority Data
Apr. 13, 2004 (EP) 04290974.7

(51) Int. Cl. B32B 7/12; B32B 37/12

(52) U.S. Cl. 428/354; 156/331.7

(57) ABSTRACT

The invention relates to a pressure-sensitive adhesive film obtained by coating a polyolefin-based support layer with an aqueous acrylic dispersion-based adhesive layer. It also relates to the coating process for obtaining this film, and to methods of using the film.

### CROSS-REFERENCE TO RELATED APPLICATIONS

This is a Divisional of U.S. patent application Ser. No. 10/599,883, filed Nov. 29, 2006, which was a 371 of PCT/FR2005/000606 filed Mar. 14, 2005, which claimed the priority of EP 04290974.7 filed Apr. 13, 2004, all three Applications are incorporated herein by reference.

### BACKGROUND OF THE INVENTION

1. Field of the Invention

The invention relates to a pressure-sensitive adhesive film and to its manufacturing process.

The invention is applicable in the field of the protection of motor-vehicle bodies.

2. Description of Related Art

Freshly lacquered motor-vehicle bodies have to be protected, especially by means of a protective film, against dirt and damage brought about during assembly, transportation and storage of the vehicle.

The protective film may be applied to the bodies using an application machine or by hand, but whatever the method of application, since the surfaces are not flat, there are always air bubbles or moisture between the lacquer and the film. These specific application conditions, added to prolonged natural exposure, and in particular exposure to high temperatures, result, after the film has been stripped off, in the presence of marks at the place corresponding to the periphery of the bubbles.

The motor vehicle market today requires the amount and/or the size of these marks to be minimized, or even for them to disappear after a period of natural exposure.

No standard method exists for quantifying this marking. However, the lacquers applied to motor-vehicle bodies exhibit a surface roughness which, in two dimensions, can be modelled by a superposition of sinusoids of different amplitudes and different wavelengths. The roughness state is generally characterized by a fundamental amplitude H₀ and by a fundamental wavelength L₀, as shown in FIG. 1.

The marks are due to deformation of the lacquer and have a profile, in two dimensions, that can be modelled by a curve characterized by an amplitude H and a width L, as shown in FIG. 2. The H and L values may be measured by tactile profilometry. In general, these marks remain invisible to an observer as long as the value L is greater than or equal to L₀-0.15 mm and as long as the value H is less than or equal to H₀+0.15 μm (the resolution of the human eye at a distance of 30 cm is about 0.1 mm). These values are such that the contrast between the mark and the lacquer is minimized.

The protective films currently used comprise a support layer and an adhesive layer formed on the latter, if it is coated, via a solvent phase. For example, Patent Application EP-A-0 519 278 discloses a film obtained by coating a rubber in a solvent phase onto a polyolefin support layer, the modulus of the adhesive being between 2×10⁴ and 70×10⁴ Pa at 60° C. U.S. Pat. No. 5,925,456 discloses a film obtained, either by coating an EVA-based mixture in a solvent phase onto a polyolefin support, or by coextrusion, and the adhesive layer of which has a loss tangent tan δ of between 0.6 and 1.0 measured at 60° C. and 10⁻² Hz, and between 0.4 and 0.7 measured at 60° C. and 10 Hz.

These films produce an amount of marks that is tolerable for the motor vehicle market, but if they require the use of products in a solvent phase they are unsatisfactory from the environmental standpoint.

Also known, from Patent Application EP-A-0 826 542 is a protective film for motor vehicle windows, the adhesive layer of which, of the polyurethane type, has a low level of adhesion. Patent Application WO 01/96489 discloses a protective film whose adhesive part, coated on a support layer, is based on a crosslinked polyurethane. This adhesive layer is characterized by a loss tangent tan δ that rapidly increases from 10⁻¹ to 10² rad/s at ambient temperature, or does not vary. However, the properties of this protective film do not prevent the presence of marks or residues on the surface of a motor vehicle lacquer after the protective layer has been removed. In addition, the level of adhesion of the film is too low compared with that required by the market.

### SUMMARY OF THE INVENTION

It has now been discovered, and it is this that forms the basis of the invention, that a particular acrylic aqueous dispersion combined with a crosslinking system that can be incorporated in an aqueous phase makes it possible to prepare protective films for motor vehicle bodies that do not have the abovementioned drawbacks (marks, low level of adhesion, use of a solvent) and no premature transfer of adhesive after natural exposure (for example 6 months in Florida). These films may for example protect lacquers of the acrylic-melamine, alkyd-melamine, polyurethane or other type, it being possible for these lacquers to be of the one-component or two-component (1K or 2K) type.

### BRIEF DESCRIPTION OF THE DRAWINGS

FIG. 1 illustrates curves showing the superposition of sinusoids of different amplitudes and different wavelengths characterizing the roughness state of the lacquers applied to a motor-vehicle body.

FIG. 2 illustrates curves modeling the profile of marks in automotive body lacquer.

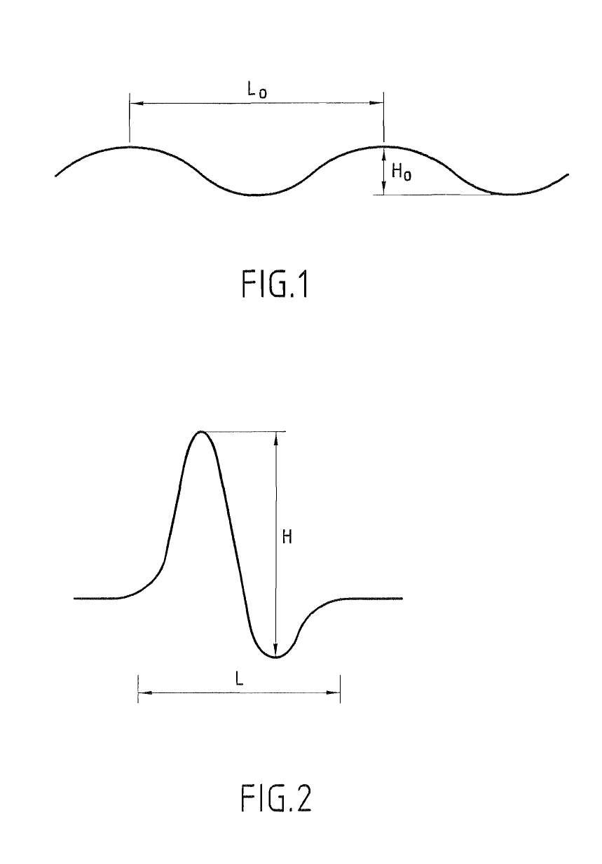

### DETAILED DESCRIPTION OF THE INVENTION

Thus, according to a first aspect, the subject of the invention is a pressure-sensitive adhesive film particularly suitable for protecting motor vehicle bodies.

This pressure-sensitive adhesive film is obtained by coating a support layer with a mixture containing:
100 parts by weight of an aqueous acrylic dispersion obtained by emulsion polymerization of a monomer mixture comprising 40 to 70% by weight of 2-ethylhexyl acrylate, 20 to 40% by weight of ethyl acrylate, 5 to 15% by weight of vinyl acetate, 0 to 8% by weight of styrene and 2 to 5% by weight of one or more monomers carrying at least one carboxylic group;
0.05 to 30 parts by weight, preferably 0.1 to 15.5 parts by weight, of a crosslinking system that can be incorporated in aqueous phase; and
0 to 5 parts by weight of one or more anti-ageing agents.

Of course, the sum of the various constituents of the acrylic dispersion is equal to 100%.

The monomer carrying the carboxylic group(s) is advantageously chosen from acrylic acid, methacrylic acid, itaconic acid, citraconic acid, fumaric acid, maleic acid and derivatives of these acids, acrylic acid and/or methacrylic acid being preferred.

Advantageously, the mean particle size of the aqueous acrylic dispersion is less than 500 nm, preferably less than 200 nm.

This aqueous acrylic dispersion may be obtained by a conventional emulsion polymerization process, for example according to the process described in Patent Application EP 1 378 527 A incorporated by reference in the present application.

As a particularly preferred example of such a dispersion, mention may be made of the product currently sold under the name ACRONAL®0 DS3559 (from BASF). This product has in particular the following physico-chemical characteristics:
Solids content: 52±1%;
Density: about 1.05 g/cm³;
pH: between 5.0 and 6.5;

Viscosity at 23° C. (DIN 53211): 17 to 20 s;
T_{g}≈−30° C.

The crosslinking system used to prepare the adhesive mixture intended to coat the support layer advantageously consists of one or more crosslinking agents chosen from crosslinkers of the aliphatic or alicyclic isocyanate type, crosslinkers of the aziridine type, crosslinkers of the carbodiimide type and crosslinkers of the epoxy type.

This crosslinking system must be able to be made compatible with the aqueous phase of the acrylic dispersion.

According to various preferred embodiments of the invention, the aforementioned crosslinking system consists of:
either an isocyanate used in an amount of 0.5 to 30 parts by weight, preferably 1 to 15 parts by weight;
or an aziridine used in an amount of 0.05 to 3 parts by weight, preferably 0.1 to 1.5 parts by weight;
or a carbodiimide used in an amount of 0.1 to 30parts by weight, preferably 0.1 to 15 parts by weight;
or an epoxy used in an amount of 0.1 to 6 parts by weight, preferably 0.2 to 3 parts by weight;
or a mixture of an aziridine used in an amount of 0.05 to 0.5 parts by weight and of an isocyanate used in an amount of 1 to 15 parts by weight.

As examples of aliphatic isocyanate crosslinkers that can be used within the context of the invention, mention may be made of aliphatic diisocyanates, such as hexamethylene diisocyanate and trimers of these diisocyanates, aliphatic triisocyanates and polymers resulting from these homopolymerized or copolymerized monomers, or resulting from the addition of a polyol or of a polyamine with one or more or these monomers, it being possible for the polyol or the polyamine to be a polyether, a polyester, a polycarbonate or a polyacrylate.

As examples of alicyclic isocyanate crosslinkers that can be used within the context of the invention, mention may be made of alicyclic diisocyanates, such as 3-isocyanatomethyl-3,5,5-trimethylcyclohexyl isocyanate (better known under the name isophorone diisocyanate or IPDI) or hydrogenated diphenylmethane diisocyanate, and trimers of these diisocyanates, and alicyclic triisocyanates, and also polymers resulting from these homopolymerized or copolymerized monomers, or resulting from the addition of a polyol or of a polyamine with one or more of these monomers, it being possible for the polyol or the polyamine to be a polyether, a polyester, a polycarbonate or a polyacrylate.

As examples of aziridine crosslinkers that can be used within the context of the invention, mention may be made of trimethylolpropane tris(3-aziridinylpropionate, trimethylolpropane tris(3-(2-methylaziridinyl)propionate), trimethylolpropane tris [2-aziridinylbutyrate], trimethylolpropane tris-[β-(N-aziridinyl)propionate], tris(1-aziridinyl)phosphine oxide, tris(2-methyl-1-aziridinyl) phosphine oxide, pentaerythritol tris [3-(1-aziridinyl)propionate], pentaerythritol tris [β-(N-aziridinyl)propionate] and pentaerythritol tetrakis [3-(1-aziridinyl) propionate].

As examples of carbodiimide crosslinkers that can be used within the context of the invention, mentioned may be made of 1-ethyl-3-(3-dimethylaminopropyl)]carbodiimide, 1-[3-(dimethylamino)propyl]-3-ethylcarbodiimide, 1,3-dicyclohexylcarbodiimide, N-cyclohexyl-N′-(methylpolystyrene)] carbodiimide and salts of these compounds.

As examples of epoxy crosslinkers that can be used within the context of the invention, mention may be made of oxazolines and acryloxazolines.

The aforementioned adhesive mixture may comprise 0 to 5 parts by weight, and preferably 0 to 3 parts by weight, of one or more anti-ageing agents.

The anti-ageing agents that can be used within the context of the invention are advantageously chosen from primary or secondary antioxidants, sterically hindered amines or HALS (Hindered Amine Light Stabilizers). It is possible to use several agents of the same type, or else a mixture of agents of different types.

The primary antioxidants prevent degradation of the material by absorbing the free radicals formed through the action of heat. The secondary antioxidants prevent degradation of the material by absorbing the hydroperoxides formed in the medium by reaction of peroxide radicals with the polymer.

As examples of antioxidants that can be used within the context of the invention, mention may be made of phenolic antioxidants (IRGANOX®1010 and 1135 from Ciba Specialty Chemicals), amine antioxidants (IRGANOX® 5057), phosphites (IRGAFOS® 168) and thioethers.

Sterically hindered amines or HALS prevent the degradation of the material by absorbing the free radicals and the hydroperoxides that are formed in the medium through the action of UV radiation.

As examples of sterically hindered amines that can be used within the context of the invention, mention may be made of the products sold under the names CHIMASSORB® 2020 and TINUVIN® 783, 770 and 765.

According to a particularly preferred embodiment, the aforementioned adhesive mixture contains a mixture of antioxidants and sterically hindered amines (HALS) as anti-ageing agents.

The adhesive mixture may also contain one or more additives, such as anti-blocking agents, UV absorbers, plasticizers, wetting agents, anti-foam agents, spreading agents, tackifying resins, and materials, apart from those mentioned above, for adjusting the level of adhesion.

The tackifying resins that can be used within the context of the invention are well known to those skilled in the art and may be chosen in particular from colophony resins, terpene-phenol resins and resins obtained from C₅, (C₅)₂ and/or C₉ petroleum cuts that may then be partially or completely hydrogenated. Advantageously, these resins have a softening temperature, measured according to the ring-and-ball method (ASTM E 28 standard) of less than or equal to 140° C., generally lying within the 75 to 140° C. range and preferably within the 75 to 125° C. range. As examples, mention may be made of the products sold under the name ESCOREZ® (from Exxon), SYLVARES® (from Arizona) and PERMALYN® (from Eastman).

These additives are generally present in an amount lying within the range of 0.1 to 10% by weight relative to the weight of the adhesive layer.

The thickness of the adhesive layer formed from the aforementioned mixture is generally between 5 and 30 microns, preferably between 5 and 25 microns and more preferably between 8 and 20 microns.

The support layer for the pressure-sensitive adhesive film according to the invention is based on one or more polyolefins. This support layer may be of the monolayer type or multilayer type, preferably of the trilayer type.

As examples of polyolefins that can be used in each layer of the support layer, mention may b_{e ma}de of radical polyethylenes (PEs); medium-density, low-density or very low-density linear PEs; polypropylenes (PPs); ethylene-propylene copolymers (EPDMs); and blends of these compounds.

The expression “blend of these compounds” includes, within the meaning of the present invention, a blend of several polymers of the same type, or a blend of one or more polymers of a first type with one or more polymers of one or more other types.

The radical PE may be of low density (0.910≦d≦0.925), medium density (0.925<d ≦0.940) or high density (0.940<d≦0.960).

Linear PEs are copolymers of ethylene with a C₃-C₈ olefinic monomer, such as propene, butene, hexene, methylpentene or octene. Advantageously, low-density or very low-density linear PEs are used, that is to say those having a density, measured according to the ASTM D 1505 standard, lying within the 0.850 to 0.936 range.

Advantageously, the PP has a density, measured according to the ASTM D 1505 standard, lying within the 0.890 to 0.910 range.

The EPDMs preferably have a density, measured according to the ASTM D 1505 standard, lying within the 0.84 to 0.90 range and advantageously a propylene content lying within the 25 to 60% by weight range.

The support layer may also contain one or more polyolefins intended to increase the bonding of the adhesive layer and the support layer.

As examples of polyolefins intended to increase the bonding of the adhesive layer and the support layer, mention may be made of ethylene/vinyl acetate (EVA) copolymers, ethylene/acrylic derivative (EDA) copolymers and blends of these compounds.

According to the invention, the EVAs have a vinyl acetate (VA) content of less than or equal to 80% by weight, preferably less than or equal to 30% by weight. Advantageously, these EVAs have a melt flow index, measured according to the ASTM 1238 standard, lying within the 0.1 to 40 dg/min range, preferably within the 0.1 to 10 dg/min range.

The EDAs preferably have an acrylic derivative content, such as for example butyl acrylate and/or (meth)acrylic acid, of less than or equal to 40% by weight. These EDAs advantageously have a melt flow index, measured according to the ASTM 1238 standard, lying within the 0.1 to 40 dg/min range, preferably within the 0.1 to 10 dg/min range.

The support layer may also contain one or more additives such as slip agents, processing aids, matting agents, dyes or pigments, anti-ageing agents, UV absorbers and anti-blocking agents. When the support layer is of the multilayer type, each of the layers may contain the said additives.

These additives are generally present in an amount lying within the 0.1 to 25% by weight range relative to the weight of the support layer.

According to one particularly preferred embodiment, the support layer is of the trilayer type.

The central layer comprises between 50 and 90%, preferably between 75 and 85%, of an ethylene-propylene copolymer, between 5 and 30%, preferably between 5 and 15%, of a linear low-density polyethylene, between 1 and 10%, preferably between 1 and 5%, of a radical low-density polyethylene, between 0 and 15%, preferably between 5 and 10%, of a white titanium dioxide pigment, between 0 and 5%, preferably between 0.05 and 3%, of an anti-blocking agent, between 0 and 5%, ₚreferably between 0.01 and 3%, of a processing aid of the fluoroelastomer type, between 0 and 5%, preferably between 1 and 3%, of an anti-ageing agent and/or a UV absorber.

The external layer comprises between 50 and 90%, preferably between 70 and 80%, of a radical low-density polyethylene, between 0 and 40%, preferably 10 and 30%, of a linear low-density polyethylene, between 0 and 15%, preferably between 5 and 10%, of a white titanium dioxide pigment, between 0 and 5%, preferably between 0.05 and 3%, of an anti-blocking agent, between 0 and 5%, preferably between 0.01 and 3%, of a processing aid of the fluoroelastomer type, between 0 and 5%, preferably between 1 and 3%, of an anti-ageing agent and/or a UV absorber.

The layer in contact with the adhesive layer comprises between 60 and 90%, preferably between 70 and 80%, of a radical low-density polyethylene, between 0 and 40%, preferably between 20 and 30%, of a linear low-density polyethylene, between 0 and 15%, preferably between 5 and 10%, of a white titanium dioxide pigment, between 0 and 5%, preferably between 0.05 and 3%, of an anti-blocking agent, between 0 and 5%, preferably between 0.01 and 3%, of a processing aid of the fluoroelastomer type, between 0 and 5%, preferably between 1 and 3%, of an anti-ageing agent and/or a UV absorber.

The layer thicknesses are between 10 and 30% of the total thickness in the case of the external layer, between 10 and 30% of the total thickness in the case of the layer in contact with the adhesive, and between 40 and 80% of the total thickness in the case of the central layer.

The support layer is obtained by (co)extrusion of the polyolefin(s) and of the additives optionally present, and is corona-treated or plasma-treated.

its thickness is generally between 10 and 100 microns, preferably between 35 and 70 microns and more preferably between 40 and 60 microns.

According to one particular embodiment, the adhesive film according to the invention comprises, on the other side from the support layer (that is to say the side that is not in contact with the adhesive layer) an advantageously non-stick protective layer. Such a protective layer is well known to those skilled in the art.

The pressure-sensitive adhesive film according to the invention is obtained by coating the support layer with the aforementioned adhesive compound using ₜechniques well known to those skilled in the art.

According to a second aspect, the subject of the invention is a process for manufacturing a pressure-sensitive adhesive film suitable for protecting motor vehicle bodies, characterized in that it comprises the coating of a support layer with a mixture containing:
100 parts by weight of an aqueous acrylic dispersion obtained by emulsion polymerization of a monomer mixture comprising 40 to 70% by weight of 2-ethylhexyl acrylate, 20 to 40% by weight of ethyl acrylate, 5 to 15% by weight of vinyl acetate, 0 to 8% by weight of styrene and 2 to 5% by weight of one or more monomers carrying at least one carboxylic group;
0.05 to 30 parts by weight, preferably 0.1 to 15.5 parts by weight, of a crosslinking system that can be incorporated in aqueous phase; and
0 to 5 parts by weight of one or more anti-ageing agents
   under coating conditions allowing a coated adhesive layer to be obtained having a thickness of between 5 and 30 microns and a residual moisture content of between 0.001 and 1% by weight.

According to one particular feature, the aforementioned coating operation includes a drying step carried out at an oven of temperature of between 50 and 95° C., and a time for the film to pass through the oven of between 1 and 30 seconds, thus making it possible to achieve the aforementioned thickness and the aforementioned moisture content.

In general, the film thus obtained has a level of adhesion, measured by a debonding force (180° peel, peel rate=300 mm/min, measured at room temperature) of between 40 and 350 cN/cm. After temperature, moisture or UV tests, or by combining these constraints (for example 14 days of cycling (6 hours at 23° and 100% relative humidity, then 6 hours at 40° C. and 100% relative humidity)), the level of adhesion is between 40 and 500 cN/cm and the surfaces after the protective film has been removed have a level of adhesive marks or residues that is acceptable for the motor vehicle market.

According to a third aspect, the subject of the invention is the use of the pressure-sensitive adhesive film as defined above for protecting motor vehicle bodies.

According to another aspect, the object of the invention is to provide motor vehicle bodies protected by the said pressure-sensitive adhesive film.

The invention is illustrated by the examples below, these being given purely by way of indication.

### EXAMPLE 1

An adhesive composition was prepared by mixing 100 parts by weight of an acrylic dispersion (ACRONAL® DS3559) and 3 parts by weight of isocyanate crosslinker (VESTANAT® IPDI (from Degussa)) so as to obtain a solids content of 50% for the composition. The isocyanate crosslinker was introduced into the dispersion in the form of a 25% preblend in ethyl acetate.

A support film was manufactured using three-layer coextrusion equipment, by cast or blown coextrusion, under normal conditions known to those skilled in the art. A radical polyethylene of 0.924 density and 0.7 melt flow index was introduced into Extruder 1; a 90/10 blend by weight of radical polyethylene of 0.924 density and 0.7 melt flow index and of linear polyethylene (butene comonomer) of 0.925 density and 0.7 melt flow index was introduced into Extruder 2; and a radical polyethylene of 0.924 density and 0.7 melt flow index was introduced into Extruder 3. A colouring agent (TiO₂) was incorporated in order to give the film a white matt appearance. A processing aid was used to facilitate the extrusion. An anti-blocking agent and a

UV absorber were also used. This film had a thickness of 55 microns. The surface intended to be in contact with the adhesive layer was then corona-treated.

The adhesive composition was coated onto the support film under the normal conditions known to those skilled in the art, so as to obtain a dry coating of 20 g/m², equivalent to a thickness of 20 microns, the coating then being dried at 85° C. for 5 seconds.

This film, applied manually to a prelacquered motor-vehicle plate, the lacquer being of the polyurethane type, had, one hour after having been applied, a level of adhesion measured by a debonding force (180° peel, peel rate=300 mm/min, measured at room temperature) of about 200 cN/cm. After a QUV-type test for 300 hours (cycling for 4 hours at 40° C. and 100% humidity followed by 4 hours under UV radiation), the level of adhesion was about 300 cN/cm and the motor vehicle lacquer had few marks or residues of adhesive after the protective layer had been removed.

### EXAMPLE 2

An adhesive composition was prepared by mixing 100 parts by weight of an acrylic dispersion (ACRONAL®0 DDS3559) and 3 parts by weight of isocyanate crosslinker (DESMODUR® DA-L (from Bayer)) so as to obtain a solids content of 50% for the composition. The isocyanate crosslinker was introduced into the dispersion in the form of a 50% preblend in ethyl acetate. An anti-ageing agent (TINUVIN® 770) wₐₛ incorporated into the mixture in an amount of 0.5 parts by weight.

A support film was manufactured using three-layer coextrusion equipment, by cast or blown coextrusion, under normal conditions known to those skilled in the art. A radical polyethylene of 0.924 density and 0.7melt flow index was introduced into Extruder 1; a 90/10 blend by weight of radical polyethylene of 0.924 density and 0.7 melt flow index and of linear polyethylene (butene comonomer) of 0.925 density and 0.7 melt flow index was introduced into Extruder 2; and a radical polyethylene of 0.924 density and 0.7 melt flow index was introduced into Extruder 3. A colouring agent (TiO₂) was incorporated in order to give the film a white matt appearance. A processing aid was used to facilitate the extrusion. An anti-blocking agent and a CV absorber were also used. This film had a thickness of 45 microns. The surface intended to be in contact with the adhesive layer was then corona-treated.

The adhesive composition was coated onto the support film under the normal conditions known to those skilled in the art, so as to obtain a dry coating of 20 g/m², equivalent to a thickness of 20 microns, the coating then being dried at 85° C. for 5 seconds.

This film, applied manually to a prelacquered motor-vehicle plate, the lacquer being of the polyurethane type, had, one hour after having been applied, a level of adhesion measured by a debonding force (180° peel, peel rate=300 mm/min, measured at room temperature) of about 210 cN/cm. After a QUV-type test for 300 hours (cycling for 4 hours at 40° C. and 100% humidity followed by 4 hours under UV radiation), the level of adhesion was about 310 cN/cm and the motor vehicle lacquer had few marks or residues of adhesive after the protective layer had been removed.

### EXAMPLE 3

An adhesive composition was prepared by mixing 100 parts by weight of an acrylic dispersion (ACRONAL® DS3559), one part by weight of isocyanate crosslinker (DESMODUR® DA-L (from Bayer)) and 0.15 parts by weight of aziridine crosslinker (NEOCRYL CX100®) so as to obtain a solids content of 50% for the composition. The isocyanate crosslinker was introduced into the dispersion in the form of a 50% preblend in ethyl acetate. The aziridine crosslinker was introduced into the dispersion in the form of a 50% preblend in methoxypropanol acetate. An anti-ageing agent (TINUVIN® 770) was incorporated into the mixture in an amount of 0.5 parts by weight.

A support film was manufactured using three-layer coextrusion equipment, by cast or blown coextrusion, under normal conditions known to those skilled in the art. A radical polyethylene of 0.924 density and 0.7 melt flow index was introduced into Extruder 1; a 90/10 blend by weight of radical polyethylene of 0.924 density and 0.7 melt flow index and of linear polyethylene (butene comonomer) of 0.925 density and 0.7 melt flow index was introduced into Extruder 2; and a radical polyethylene of 0.924 density and 0.7 melt flow index was introduced into Extruder 3. A colouring agent (TiO₂) was incorporated in order to give the film a white matt appearance. A processing aid was used to facilitate the extrusion. An anti-blocking agent and a UV absorber were also used. This film had a thickness of 45 microns. The surface intended to be in contact with the adhesive layer was then corona-treated.

The adhesive composition was coated onto the support film under the normal conditions known to those skilled in the art, so as to obtain a dry coating of 20 g/m², equivalent to a thickness of 20 microns, the coating then being dried at 85° C. for 5 seconds.

This film, applied manually to a prelacquered motor-vehicle plate, the lacquer being of the polyurethane type, had, one hour after having been applied, a level of adhesion measured by a debonding force (180° peel, peel rate=300 mm/min, measured at room temperature) of about 210 cN/cm. After a QUV-type test for 300 hours (cycling for 4 hours at 40° C. and 100% humidity followed by 4 hours under UV radiation), the level of adhesion was about 310 cN/cm and the motor vehicle lacquer had few marks or residues of adhesive after the protective layer had been removed.

### EXAMPLE 4

An adhesive composition was prepared by mixing 100 parts by weight of an acrylic dispersion (ACRONAL® A240) and 3 parts by weight of an isocyanate crosslinker (DESMODUR® DA-L) so as to obtain a 50% solids content for the composition. The isocyanate crosslinker was introduced into the dispersion in the form of a 50% preblend in ethyl acetate. An anti-ageing agent (IRGANOX® 5057) was incorporated into the mixture in an amount of 0.5 parts by weight.

A support film was manufactured using three-layer coextrusion equipment, by cast or blown coextrusion, under normal conditions known to those skilled in the art. A radical polyethylene of 0.924 density and 0.7melt flow index was introduced into Extruder 1; a 90/10 blend by weight of radical polyethylene of 0.924 density and 0.7 melt flow index and of linear polyethylene (butene comonomer) of 0.925 density and 0.7 melt flow index was introduced into Extruder 2; and a 60/40 blend by weight of radical polyethylene of 0.924 density and 0.7 melt flow index, and of ethylene-vinyl acetate copolymer (93/7) of 2.5 melt flow index was introduced into Extruder 3, the layer obtained from the latter blend being intended to be the coated layer. A colouring agent (TiO₂) was incorporated in order to give the film a white matt appearance. A processing aid was used to facilitate the extrusion. An anti-blocking agent and a UV absorber were also used. This film had a thickness of 40 microns. The surface intended to be in contact with the adhesive layer was then corona-treated.

The adhesive composition was coated onto the support film under the normal conditions known to those skilled in the art, so as to obtain a dry coating of 15 g/m², equivalent to a thickness of 15 microns, the coating then being dried at 85° C. for 5 seconds.

This film, applied manually to a prelacquered motor-vehicle plate, the lacquer being of the polyurethane type, had, one hour after having been applied, a level of adhesion measured by a debonding force (180° peel, peel rate=300 nm/min, measured at room temperature) of about 210 cN/cm. After a temperature/wet-atmosphere test for 14 days (cycling for 6 hours at 23° C. and 100% relative humidity followed by 6 hours at 40° C. and 100% relative humidity), the motor vehicle lacquer had few adhesive marks or residues after the protective film was removed.

### EXAMPLE 5

An adhesive composition was prepared by mixing 100 parts by weight of an acrylic dispersion (ACRONAL® DS3559), 30 parts by weight of ACRONAL® LA449S and 0.25 parts by weight of an aziridine crosslinker (NEOCRYL CX100®) so as to obtain a solids content of 50% for the composition. The isocyanate crosslinker was introduced into the dispersion in the form of a 50% preblend in ethyl acetate. The aziridine crosslinker was introduced into the dispersion in the form of a 50% preblend in methoxypropanol acetate. An anti-ageing agent (IRGANOX® 5057) was incorporated into the mixture in an amount of 0.5 parts by weight.

A support film was manufactured using three-layer coextrusion equipment, by cast or blown coextrusion, under normal conditions known to those skilled in the art. A radical polyethylene of 0.924 density and 0.7 melt flow index was introduced into Extruder 1; a 90/10 blend by weight of radical polyethylene of 0.924 density and 0.7 melt flow index and of linear polyethylene (butene comonomer) of 0.925density and 0.7 melt flow index was introduced into Extruder 2; and a 60/40 blend by weight of radical polyethylene of 0.924 density and 0.7 melt flow index, and of ethylene-vinyl acetate copolymer (93/7) of 2.5 melt flow index was introduced into Extruder 3, the layer obtained from the latter blend being intended to be the coated layer. A colouring agent (TiO₂) was incorporated in order to give the film a white matt appearance. A processing aid was used to facilitate the extrusion. An anti-blocking agent and a UV absorber were also used. This film had a thickness of 40 microns. The surface intended to be in contact with the adhesive layer was then corona-treated.

The adhesive composition was coated onto the support film under the normal conditions known to those skilled in the art, so as to obtain a dry coating of 20 g/m², equivalent to a thickness of 20 microns, the coating then being dried at 85° C. for 5 seconds.

This film, applied manually to a prelacquered motor-vehicle plate, the lacquer being of the polyurethane type, had, one hour after having been applied, a level of adhesion measured by a debonding force (180° peel, peel rate=300 mm/min, measured at room temperature) of about 150 cN/cm. After a temperature/wet-atmosphere test for 14 days (cycling for 6 hours at 23° C. and 100% relative humidity followed by 6 hours at 40° C. and 100% humidity), the motor vehicle lacquer had few adhesive marks or residues after the protective film was removed.

### EXAMPLE 6

An adhesive composition was prepared by mixing 100 parts by weight of an acrylic dispersion (ACRONAL® DS3559) and 0.25 parts by weight of an aziridine crosslinker (NEOCRYL CX100®) so as to obtain a 50% solids content for the composition. The aziridine crosslinker was introduced into the dispersion in the form of a 50% preblend in methoxypropanol acetate. An anti-ageing agent, consisting of a mixture of 0.5 parts by weight of TINUVIN® 765 and 0.5 parts by weight of IRGANOX® 5057, was also incorporated into the mixture.

A support film was manufactured using three-layer coextrusion equipment, by cast or blown coextrusion, under normal conditions known to those skilled in the art. A radical polyethylene of 0.924 density and 0.7 melt flow index was introduced into Extruder 1; a 90/10 blend by weight of radical polyethylene of 0.924 density and 0.7 melt flow index and of linear polyethylene (butene comonomer) of 0.925 density and 0.7 melt flow index was introduced into Extruder 2; and a radical polyethylene of 0.924 density and 0.7 melt flow index was introduced into Extruder 3. A colouring agent (TiO₂) was incorporated in order to give the film a white matt appearance. A processing aid was used to facilitate the extrusion. An anti-blocking agent and a UV absorber were also used. This film had a thickness of 45 microns. The surface intended to be in contact with the adhesive layer was then corona-treated.

The adhesive composition was coated onto the support film under the normal conditions known to those skilled in the art, so as to obtain a dry coating of 20 g/m², equivalent to a thickness of 20 microns, the coating then being dried at 85° C. for 5 seconds.

When this film was applied manually to a motor vehicle plate, the outermost surface layer of which was obtained from a blend of two compounds, the second compound being of the isocyanate type, its level of adhesion, one hour after having been applied, as measured by a debonding force (180° peel, peel rate=300 mm/min, measured at room temperature) was about 240 cN/cm. After a temperature/wet-atmosphere test for 14 days (cycling for 6 hours at 23° C. and 100% humidity followed by 6 hours at 40° C. and 100% humidity), the motor vehicle lacquer had few adhesive marks or residues after the protective film was removed. More precisely, the observable marks had characteristic dimensions L and H (FIG. 2), measurable by profilometry, of 0.24 and 0.14 μm respectively. These dimensions make the marks difficult to be seen for an observer looking at the lacquer at a distance of about 30 cm.

We Claim:

1. A method of protecting a motor vehicle body which comprises applying a pressure-sensitive adhesive film to the motor vehicle body, wherein the pressure-sensitive adhesive film comprises a support layer coated with an adhesive mixture, said mixture comprising:
100 parts by weight of an aqueous acrylic dispersion obtainable by emulsion polymerization of a monomer mixture comprising 40 to 70% by weight of 2-ethylhexyl acrylate, 20 to 40% by weight of ethyl acrylate, 5 to 15% by weight of vinyl acetate, 0 to 8% by weight of styrene and 2 to 5% by weight of one or more monomers carrying at least one carboxylic group;
0.05 to 30 parts by weight of a crosslinking system that can be incorporated in aqueous phase, wherein said crosslinking system consists of one or more crosslinking agents chosen from an aliphatic or alicyclic isocyanate crosslinker, an aziridine crosslinker, a carbodiimide crosslinker and an epoxy crosslinker; and
0 to 5 parts by weight of one or more anti-ageing agents.

2. The method according to claim 1, in which the monomer carrying at least one carboxylic group is selected from acrylic acid, methacrylic acid, itaconic acid, citraconic acid, fumaric acid, maleic acid or derivatives of these acids.

3. The method according claim 1, in which the mean particle size of the aqueous acrylic dispersion is less than 500 nm.

4. The method according to claim 1, in which the crosslinking system consists of one or more crosslinking agents selected from crosslinkers of the aliphatic or alicyclic isocyanate type, crosslinkers of the aziridine type, crosslinkers of the carbodiimide type or crosslinkers of the epoxy type.

5. The method according to claim 1, in which the crosslinking system consists of:
either an isocyanate used in an amount of 0.5 to 30 parts by weight;
or an aziridine used in an amount of 0.05 to 3 parts by weight;
or a carbodiimide used in an amount of 0.1 to 30 parts by weight;
or an epoxy used in an amount of 0.1 to 6 parts by weight;
or a mixture of an aziridine used in an amount of 0.05 to 0.5 parts by weight and of an isocyanate used in an amount of 1 to 15 parts by weight.

6. The method according to claim 1, in which the support layer is a monolayer or a multilayer.

7. The method according to claim 6, in which each layer of the support layer comprises a compound selected from the group consisting of a radical polyethylene, a copolymer of ethylene and a C₃-C₈ olefinic monomer, a polypropylene, an ethylene-propylene copolymer, and a blend of these compounds.

8. The method according to claim 1, in which the support layer further includes one or more polyolefins selected from ethylene/vinyl acetate copolymers or ethylene/acrylic derivative copolymers.

9. The method according claim 3, in which the mean particle size of the aqueous acrylic dispersion is less than 200 nm.

10. The method according to claim 5, in which the crosslinking system consists of - either an isocyanate used in an amount of 1 to 15 parts by weight;
or an aziridine used in an amount of 0.05 to 3 parts by weight;
or a carbodiimide used in an amount of 0.1 to 30 parts by weight;
or an epoxy used in an amount of 0.1 to 6 parts by weight.

11. The method according to claim 6, in which the support layer is a trilayer.

12. The method according to claim 1, wherein the adhesive mixture further comprises one or more additives selected from anti-blocking agents, UV absorbers, plasticizers, wetting agents, anti-foam agents, spreading agents, tackifying resins, or agents for adjusting the level of adhesion.

13. A protected motor vehicle body obtained by the method of claim 1.
